(19) United States
(12) Patent Application Publication
(10) Pub. No.: US 2012/0023287 A1
(43) Pub. Date: Jan. 26, 2012

(54) STORAGE APPARATUS AND CONTROL METHOD THEREOF

(75) Inventor: Hideaki Fukuda, Odawara (JP)

(73) Assignee: Hitachi, Ltd., Tokyo (JP)

(21) Appl. No.: 13/251,762

(22) Filed: Oct. 3, 2011

Related U.S. Application Data
(63) Continuation of application No. 12/007,849, filed on Jan. 16, 2008.

(30) Foreign Application Priority Data
Sep. 18, 2007 (JP) 2007-241426

(51) Int. Cl. G06F 12/16

(52) U.S. Cl. 711/103; 711/E12.008; 711/E12.103

(57) ABSTRACT

This storage apparatus has a disk-shaped storage device for storing data sent from a host system, and includes a nonvolatile memory device for storing the data, a controller for controlling the reading or writing of the data sent from the host system from or into the disk-shaped storage device, and a device controller for controlling the nonvolatile memory device and the disk-shaped storage device. The device controller replicates data stored in the disk-shaped storage device to the nonvolatile memory device according to the usage of the disk-shaped storage device. The controller reads data from the nonvolatile memory device when the controller receives a data read request from the host system and corresponding data is stored in the nonvolatile memory device.

### CROSS REFERENCE TO RELATED APPLICATIONS

This application is a continuation of U.S. patent application Ser. No. 12/007,849, filed Jan. 16, 2008, which relates to and claims priority from Japanese Patent Application No. 2007-241426, filed on Sep. 18, 2007, the entire disclosure of which is incorporated herein by reference.

### BACKGROUND

The present invention relates to a storage apparatus and its control method and, for instance, can be suitably applied to a storage apparatus equipped with a hard disk drive and a flash memory.

In recent years, a flash memory as a nonvolatile memory is attracting attention as a device for storing data in addition to hard disk drives. Generally speaking, a flash memory has several times lower power consumption in comparison to a hard disk drive, and enables high speed reading of data. In addition, a flash memory is small since it does not require any mechanical drive unit as with a hard disk drive, and resistance against malfunctions is generally high.

Technology for mixing this kind of flash memory and hard disk drive, suitably controlling a plurality of storage hierarchies thereof, and allocating such storage hierarchies corresponding to the attributes of data or the polices designated in volumes has been proposed (for instance, refer to Japanese Patent Laid-Open Publication No. 2007-115232).

Nevertheless, for example, if the processor performing the I/O (Input/Output) processing with the host system is to migrate vast amounts of data from the hard disk drive to the flash memory, since the processor will spend much time to perform such migration processing, there is a possibility that the I/O processing performance with the host system will temporarily deteriorate drastically.

### SUMMARY

The present invention was devised in view of the foregoing problems. Thus, an object of this invention is to provide a storage apparatus and its control method capable of improving the access performance with the host system.

The present invention achieves the foregoing object by providing a storage apparatus having a disk-shaped storage device for storing data sent from a host system. This storage apparatus includes a nonvolatile memory device for storing the data, a controller for controlling the reading or writing of the data sent from the host system from or into the disk-shaped storage device, and a device controller for controlling the nonvolatile memory device and the disk-shaped storage device. The device controller replicates data stored in the disk-shaped storage device to the nonvolatile memory device according to the usage of the disk-shaped storage device. The controller reads data from the nonvolatile memory device when the controller receives a data read request from the host system and corresponding data is stored in the nonvolatile memory device.

Accordingly, even when data stored in the disk-shaped storage device is replicated to the nonvolatile memory device, it is possible to effectively prevent the I/O processing performance with the host system from temporarily deteriorating drastically, and considerably alleviate the load of the controller.

The present invention additionally provides a control method of a storage apparatus having a disk-shaped storage device for storing data sent from a host system. This control method of a storage apparatus includes a first step of a device controller for controlling a nonvolatile memory device for storing the data and the disk-shaped storage device replicating data stored in the disk-shaped storage device to the nonvolatile memory device according to the usage of the disk-shaped storage device, and a second step of a controller for controlling the reading or writing of the data sent from the host system from or into the disk-shaped storage device reading data from the nonvolatile memory device when the controller receives a data read request from the host system and corresponding data is stored in the nonvolatile memory device.

Accordingly, even when data stored in the disk-shaped storage device is replicated to the nonvolatile memory device, it is possible to effectively prevent the I/O processing performance with the host system from temporarily deteriorating drastically, and considerably alleviate the load of the controller.

According to the present invention, it is possible to realize a storage apparatus and its control method capable of improving the access performance with the host system.

### BRIEF DESCRIPTION OF THE DRAWINGS

FIG. 1 is a block diagram showing the schematic configuration of a storage system according to an embodiment of the present invention;

FIG. 2 is a block diagram showing the schematic configuration of an FM/HDD controller;

FIG. 3 is a conceptual diagram explaining the configuration of an FM management table;

FIG. 4 is a conceptual diagram explaining the configuration of an FM management FIFO;

FIG. 5 is a conceptual diagram explaining the configuration of a logical volume management table;

FIG. 6 is a conceptual diagram explaining the configuration of a maintenance information management table;

FIG. 7 is a flowchart showing an FM staging processing routine;

FIG. 8 is a flowchart showing an FM staging processing routine;

FIG. 9 is a flowchart showing an FM block release processing routine;

FIG. 10 is a flowchart showing the flow of writing data;

FIG. 11 is a flowchart showing a data write processing routine;

FIG. 12 is a flowchart showing a data write processing routine;

FIG. 13 is a flowchart showing the flow of reading data;

FIG. 14 is a flowchart showing a data read processing routine;

FIG. 15 is a flowchart showing an FM hit/miss determination processing routine;

FIG. 16 is a conceptual diagram explaining the configuration of a maintenance management screen; and

FIG. 17 is a block diagram showing the schematic configuration of a storage system according to another embodiment of the present invention.

### DETAILED DESCRIPTION OF THE PREFERRED EMBODIMENTS

An embodiment of the present invention is now explained in detail with reference to the attached drawings.

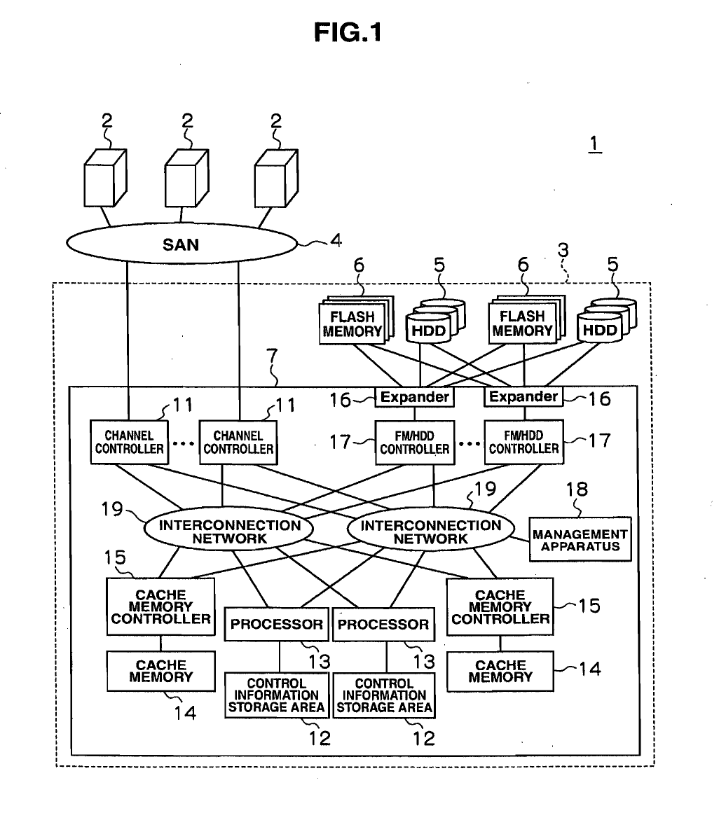

FIG. 1 shows the configuration of a storage system 1 according to the present embodiment. The storage system 1 is configured by a host system 2 and a storage apparatus 3 being connected via a SAN (Storage Area Network) 4.

The host system 2 is a computer device comprising information processing resources such as a CPU (Central Processing Unit) and a memory, and, for instance, is configured from a personal computer, a workstation or a mainframe. In addition, the host system 2 comprises a host bus adapter (FC HBA) (not shown) for connecting to the SAN 4. The host system 2 additionally comprises an information input device (not shown) such as a keyboard, a switch, a pointing device, or a microphone, and an information output device (not shown) such as a monitor display or a speaker.

The SAN 4 sends and receives commands and data between the host system 2 and the storage apparatus 3 in block units, which are management units of data in the storage resource provided by the host system 2. Here, the communication protocol to be performed between the host system 2 and the storage apparatus 3 is a fibre channel protocol.

The host system 2 and the storage apparatus 3 do not necessarily have to be connected via the SAN 4, and may also be connected via a LAN or the like. For example, when the host system 2 and the storage apparatus 3 are connected via a LAN, commands and data are sent and received according to a TCP/IP (Transmission Control Protocol/Internet Protocol). In addition, when the connection is made via a LAN, a LAN-compatible network card or the like may be used in substitute for the host bus adapter.

The storage apparatus 3 comprises a plurality of hard disk drives (HDD: Hard Disk Drives) 5 and a plurality of flash memories (FM: Flash Memories) 6 for storing data, as well as a storage controller 7 for controlling the input and output of data to and from the hard disk drives 5 and the flash memories 6.

The storage controller 7 is configured from a plurality of channel controllers 11, a plurality of processors 13 to which the control information storage areas 12 are respectively connected, a plurality of cache memory controllers 15 to which the cache memories 14 are respectively connected, a plurality of FM/HDD controllers 17 to which the expanders 16 are respectively connected, and a management apparatus 18 being connected via an interconnection network 19. The storage controller 7 is also connected to the hard disk drives 5 and the flash memories 6 via the expanders 16.

The channel controller 11 notifies the processor 13 of the request (read request or write request) received from the host system 2, and transfers data between the host system 2 and the cache memory 14 via the cache memory controller 15 based on a command (read command or write command) from the processor 13.

The processor 13 controls the overall storage controller 7 and interprets the request notified from the channel controller 11, and notifies the command to the channel controller 11 and the FM/HDD controller 17. In addition, the processor 13 is able to improve the reliability, availability and performance of the storage apparatus 3 by performing RAID (Redundant Arrays of Independent Disks) control to the hard disk drives 5.

In the foregoing case, the processor 13 operates the hard disk drives 5 according to the RAID system. The processor 13 sets one or more logical volumes (hereinafter referred to as the “logical volumes”) in a physical storage area (RAID group) provided by one or more hard disk drives 5. Data is stored in the logical volumes in block (hereinafter referred to as a “logical block”) units of a prescribed size.

A unique identifier (this is hereinafter referred to as an “LU (Logical Unit)”) is given to each logical volume. In the case of this embodiment, the input and output of data are performed by setting the combination of the foregoing LU and a number (LBA: Logical Block Address) that is unique to the respective logical blocks as the address, and designating this address.

The control information storage area 12 is a memory for storing information such as the management information of the cache memory 14 and the configuration information of the storage apparatus 3. The control information storage area 12 also stores a logical volume management table 20. The specific configuration of the logical volume management table 20 will be described later.

The cache memory controller 15 controls the cache memory 14, and stores the data transferred from the channel controller 11 or the FM/HDD controller 17 in the cache memory 14. The cache memory 14 is a memory for temporarily storing data to be stored in the hard disk drive 5 or the flash memory 6, and data to be sent to the host system 2.

FM/HDD controller 17 controls the hard disk drive 5 and the flash memory 6, and transfers data between the hard disk drive 5 and flash memory 6 and the cache memory 14 via the expander 16 based on a command from the processor 13. The FM/HDD controller 17 additionally transfers data between the hard disk drive 5 and the flash memory 6 via the expander 16 based on a command from the processor 13. The FM/HDD controller 17 is able to improve the reliability, availability and performance of the storage apparatus 3 by performing RAID (Redundant Arrays of Independent Disks) to the hard disk drives 5.

The management apparatus 18 is a management terminal for controlling the overall operation of the storage apparatus 3, and, for instance, is configured from a laptop personal computer or the like. The management apparatus 18 commands various types of processing according to the operator's operations. The operator, for example, is able to confirm the status of the storage apparatus 3 by operating the management apparatus 18 and displaying the various statuses of the storage apparatus 3 on the display unit of the management apparatus 18.

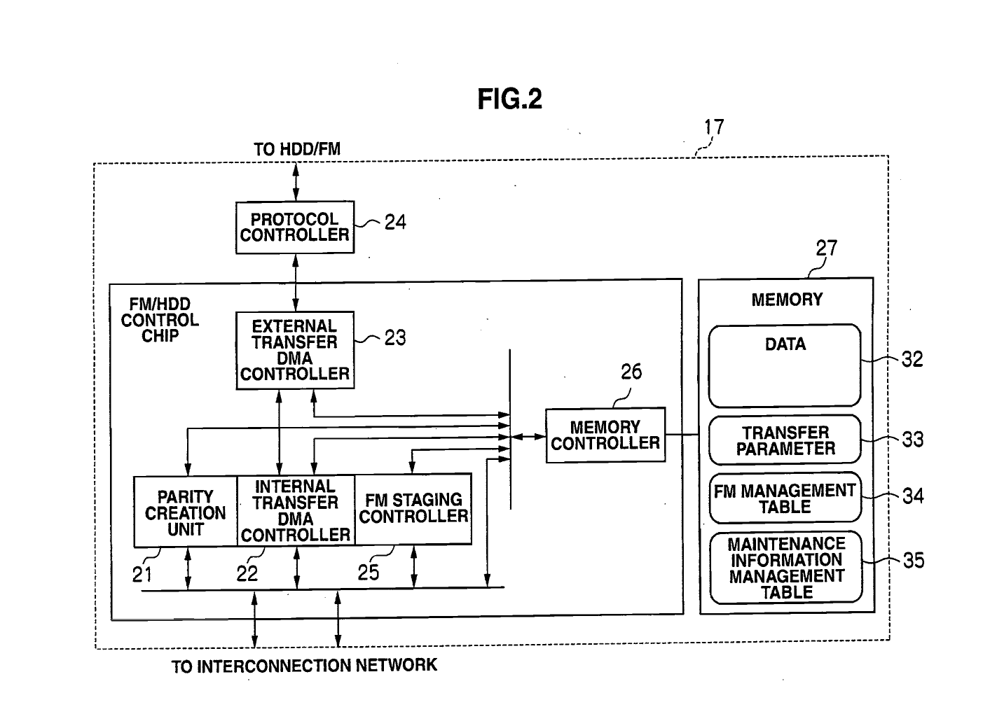

FIG. 2 shows the configuration of the FM/HDD controller 17. The FM/HDD controller 17 comprises a parity creation unit 21, an internal transfer DMA (Direct Memory Access) controller 22, an external transfer DMA controller 23, a protocol controller 24, an FM staging controller 25, a memory controller 26, and a memory 27.

The parity creation unit 21 reads data from the cache memory 14 and creates parity data via the cache memory controller 15 based on a command from the processor 13, and stores the created parity data in the cache memory 14 via the cache memory controller 15.

The internal transfer DMA controller 22 transfers data between the cache memory 14 and the memory 27 via the memory controller 26 based on a command from the processor 13.

The external transfer DMA controller 23 transfers data between the hard disk drive 5 and flash memory 6 and the memory 27 via its own external transfer DMA controller 23 and memory controller 26 based on a command from the processor 13.

The FM staging controller 25 transfers data between the hard disk drive 5 and the flash memory 6 via the expander 16 based on a command from the processor 13. In addition, an FM management FIFO (First In First Out) 31 is stored in a memory (not shown) equipped to the FM staging controller 25. The specific configuration of the FM management FIFO 31 will be described later.

The memory controller 26 controls the memory 27 and stores the data transferred from the cache memory 14 or the hard disk drive 5 or the flash memory 6 in the memory 27. The memory 27 stores data 32, transfer parameters 33, an FM management table 34, and a maintenance information management table 35.

The data 32 is data transferred from the cache memory 14 or the hard disk drive 5 or the flash memory 6. The transfer parameters 33 are parameters such as the address of the data transferred by the internal transfer DMA controller 22 and the external transfer DMA controller 23, address of the transfer destination and transfer length to be set based on a command from the processor 13. The specific configuration of the FM management table 34 and the maintenance information management table 35 will be described later.

The various tables stored in the control information storage area 12, the memory of the FM staging controller 25, or the memory 27 are now explained.

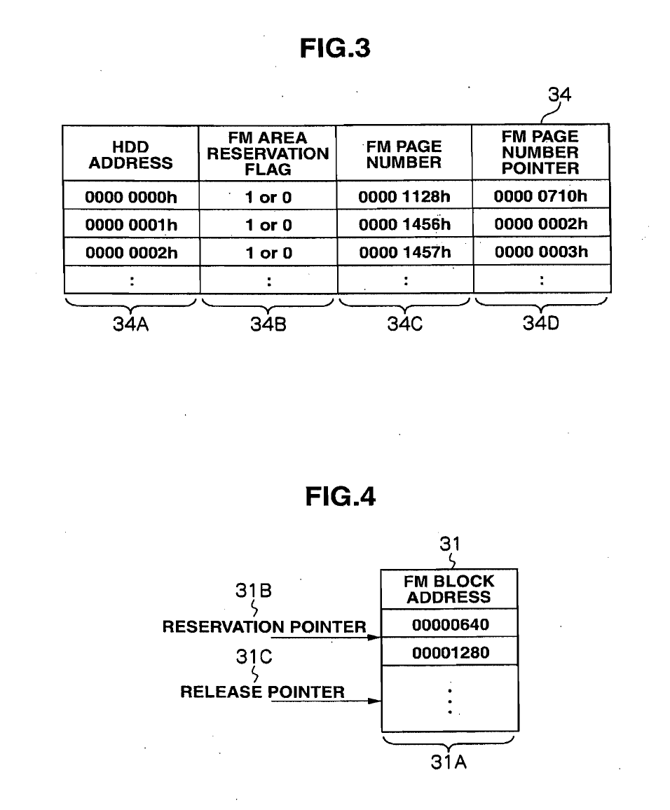

FIG. 3 shows the configuration of the FM management table 34. The FM management table 34 manages the correspondence of the address of the hard disk drive 5 and the FM page number, which is a management unit of the flash memory 6. The FM management table 34 is configured from an HDD address column 34A, an FM area reservation flag column 34B, an FM page number column 34C, and an FM page number pointer column 34D.

The management unit of the flash memory 6 is explained below. The flash memories 6 are managed for each FM block. FM blocks are managed in units of every several 100 (KB) according to an FM block address that uniquely identifies the address of the FM blocks. The FM blocks are also managed for each FM page number, which is a value obtained by adding the offset for specifying the storage position to the FM block address. The FM page numbers are managed in units of every 512 (bytes), and managed in sector units.

The hard disk drives 5 are managed in sector units; that is, in units of every 512 (bytes) based on the HDD address. With the flash memories 6, although the writing and reading of data can be performed in units of every 512 (bytes) as with the hard disk drives 5, the deletion of data can only be performed in units of every FM block. In addition, with the flash memories 6, data can only be written after data is preliminarily deleted in units of every FM block.

The HDD address column 34A stores the HDD address for uniquely identifying the address of the hard disk drives 5.

The FM area reservation flag column 34B manages whether the data stored in the HDD address is stored in the flash memory 6. “1” is stored in the FM area reservation flag column 34B when data replication (hereinafter referred to as “FM staging”) is performed from the hard disk drive 5 to the flash memory 6 on the one hand, and “0” is stored when data subject to FM staging is released. In other words, “1” is stored in the FM area reservation flag column 34B when the data stored in the HDD address is stored in the flash memory 6, and “0” is stored when the data stored in the HDD address is not stored in the flash memory 6.

The FM page number column 34C stores the FM page number. The FM page number pointer column 34D stores the HDD address of the data stored in the same FM block.

In the foregoing case, when a read command from the processor 13 is notified to the area of the HDD address in which “1” is stored in the FM area reservation flag column 34B, the FM staging controller 25 reads data from the FM page number area of the corresponding FM page number column 34C.

In addition, when a write command from the processor 13 is notified to the area of the HDD address in which “1” is stored in the FM area reservation flag column 34B, the FM staging controller 25 stores the data corresponding to the write command in the area of the HDD address, and releases the FM area reservation flag of the corresponding FM area reservation flag column 34B (changes the setting from “1” to “0”:).

Further, the FM staging controller 25 refers to the FM page number pointer of the FM page number pointer column 34D and releases the FM block by releasing the FM area reservation flag of all FM page numbers of the same FM block address. In the foregoing case, the FM staging controller 25 may delete the data stored in the FM block. The FM/HDD controller 17 is able to thereby expeditiously perform the subsequent FM staging.

FIG. 4 shows the configuration of an FM management FIFO 31. The FM management FIFO 31 manages the unused FM block addresses and averages the FM blocks to be written. The FM management FIFO 31 is configured from an FM block address column 31A, a reservation pointer 31B, and a release pointer 31C.

The FM block address column 31A stores the FM block address. The reservation pointer 31B is a pointer that indicates the border between the FM block addresses, and indicates the border of one lower FM block address each time an FM block address is reserved. The release pointer 31C is a pointer that indicates the border between the FM block addresses, and indicates the border of one lower FM block address each time an FM block address is released.

In the foregoing case, the FM management FIFO 31 shows that the FM block address that is lower than the reservation pointer 31B and higher than the release pointer 31C is an unused FM block address. The FM management FIFO 31 also shows that there is no unused FM block address when the reservation pointer 31B and the release pointer 31C are at the same position. In the FM management FIFO 31, when the reservation pointer 31B or the release pointer 31C moves down to the final FM block address, it moves back up to the first FM block address.

The FM staging controller 25 reserves an FM block address by moving the read pointer 31B to the border of one lower FM block address, and uses the foregoing FM block address. The FM staging controller 25 releases an FM block address by moving the read pointer 31B to the border of one lower FM block address, and stops the use of the foregoing FM block address. When the FM staging controller 25 is to release an FM block address, it releases all FM area reservation flags in the HDD address of the FM management table 34 corresponding to the FM block (changes the setting from “1” to “0”).

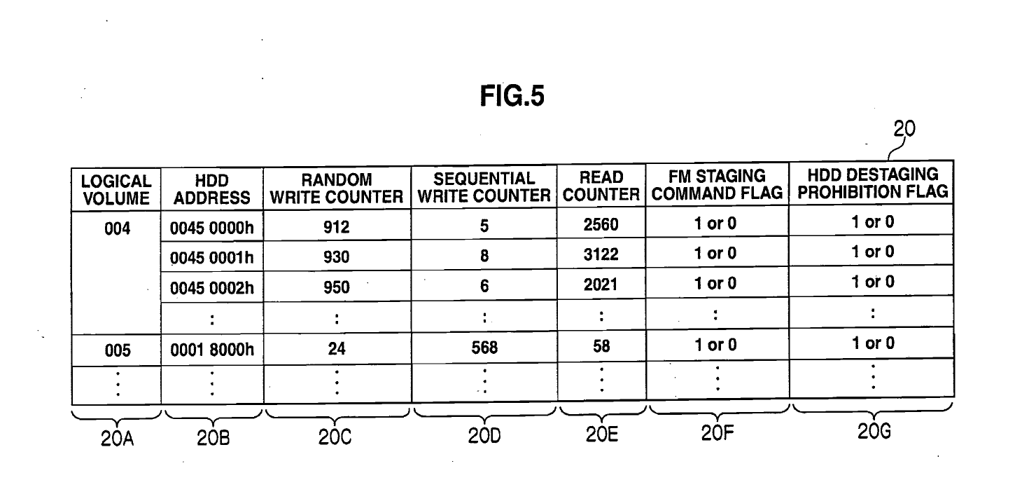

FIG. 5 shows the configuration of the logical volume management table 20. The logical volume management table 20 measures the type of high frequency access according to a counter, and is used for managing whether to perform FM staging. In the foregoing case, the FM staging controller 25 performs FM staging to data capable of leveraging the performance of the flash memory 6; that is, data with a large random write access or read access count.

The logical volume management table 20 is configured from a logical volume column 20A, an HDD address column 20B, a random write counter column 20C, a sequential write counter column 20D, a read counter column 20E, an FM staging command flag column 20F, and an HDD destaging prohibition flag column 20G.

The logical volume column 20A stores the logical volume number for uniquely identifying the logical volumes. The HDD address column 20B stores the HDD address. The random write counter column 20C stores the counted number of random write accesses made to the HDD address. The sequential write counter column 20D stores the counted number of sequential write accesses made to the HDD address. The read counter column 20E stores the counted number of read accesses made to the HDD address.

The FM staging command flag column 20F is used for managing whether to perform FM staging to data in an area of the HDD address. “1” is stored in the FM staging command flag column 20F when FM staging is to be performed, and “0” is stored when FM staging is not performed.

The HDD destaging prohibition flag column 20G is used for managing whether to prohibit the replication of data (hereinafter referred to as “HDD destaging”) from the cache memory 14 to the hard disk drive 5 in an area of the HDD address. “1” is stored in the HDD destaging prohibition flag column 20G when HDD destaging is to be prohibited, and “0” is stored when FM staging is not prohibited.

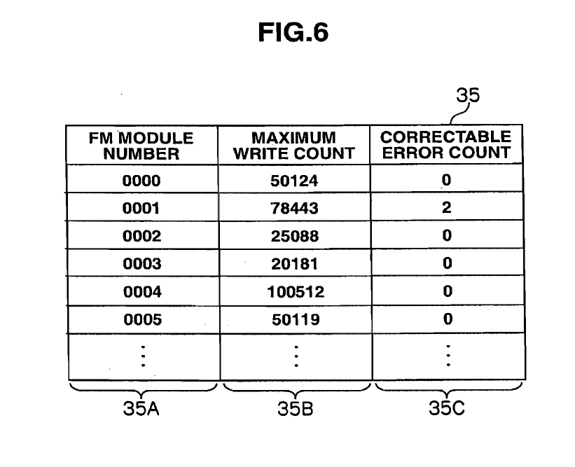

FIG. 6 shows the configuration of the maintenance information management table 35. The maintenance information management table 35 manages the correctable error count of the modularized flash memory 6.

The correctable error count is explained below. Since the flash memory 6 has a high probability of bit failure, it is equipped with an ECC (Error Correction Code) that enables continued operation even when a 1 bit failure occurs. Here, the ECC is able to correct the 1 bit and detect a 2 bit random error.

A correctable error refers to a 1 bit failure where continued operation is enabled. Normally, since operation can be continued even when a correctable error occurs, it is not necessary to replace components. Nevertheless, with a storage apparatus demanded of reliability, it is necessary to command the replacement of the flash memory 6 because, when a plurality of correctable errors occur, the probability of an uncorrectable error as a fatal error of 2 bits or higher occurring will increase. Thus, it is necessary to manage the correctable error count of the modularized flash memory 6.

The maintenance information management table 35 is configured from an FM module number column 35A, a maximum write count column 35B, and a correctable error count column 35C.

The FM module number column 35A stores the FM module number for uniquely identifying the modularized flash memory 6. The maximum write count column 35B stores the maximum write count, which is the write count of the FM block with the greatest write count among the modularized flash memories 6. The correctable error count column 35C stores the correctable error count of the modularized flash memory 6. The memory controller 26 measures and manages the write count and correctable error count of the flash memory 6.

The FM staging processing to be performed by the storage apparatus 3 of the storage system 1 according to the present embodiment is now explained.

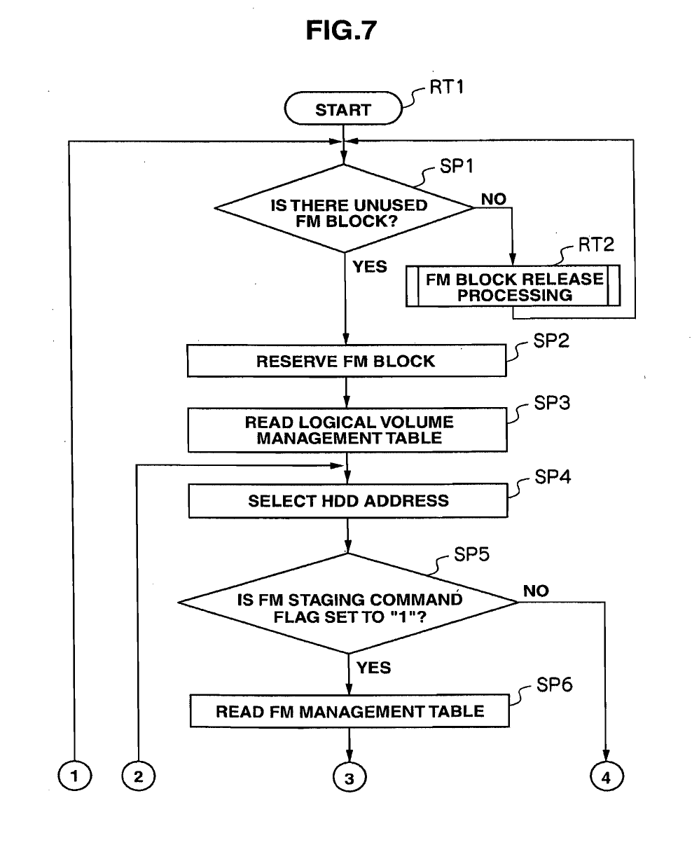

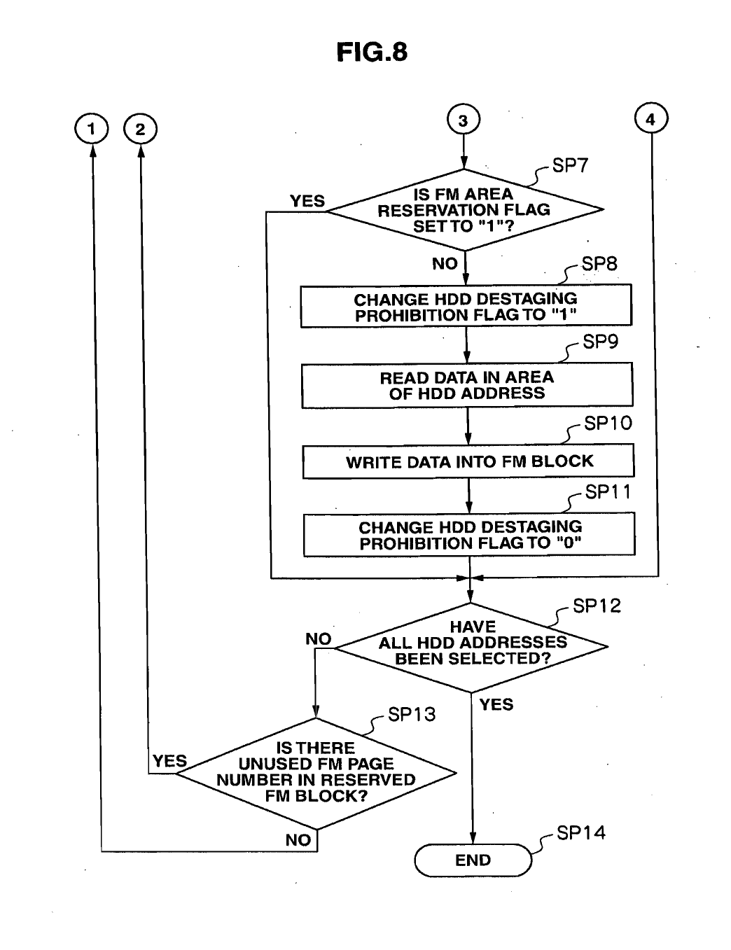

FIG. 7 and FIG. 8 are examples of flowcharts showing a specific processing routine of the FM staging controller 25 of the storage apparatus 3 concerning the FM staging processing to be performed by the storage apparatus 3 of the storage system 1.

When an FM staging execution command is notified from the processor 13, the FM staging controller 25 executes the control programs (not shown) in the FM staging controller 25 in order to refer to the FM management FIFO 31 and check whether there is an unused FM block according to the FM staging processing routine RT1 shown in FIG. 7 and FIG. 8 (SP1).

Specifically, the FM staging controller 25 determines that there is an unused FM block when there is an FM block address that is lower than the reservation pointer 31B and higher than the release pointer 31C, and determines that there is no unused FM block when the reservation pointer 31B and the release pointer 31C are at the same position.

If there is no unused FM block (SP1: NO), the FM staging controller 25 executes FM block release processing (RT2). The FM block release processing will be described later. Meanwhile, if there is an unused FM block (SP1: YES), the FM staging controller 25 moves the reservation pointer 31B of the FM management FIFO 31 and reserves the FM block (SP2).

Subsequently, the FM staging controller 25 reads the logical volume of the logical volume management table 20 read from the control information storage area 12 (SP4).

Subsequently, the FM staging controller 25 checks whether the FM staging command flag of the selected HDD address is set to “1” (SP5). If the FM staging command flag of the selected HDD address is not set to “1”; that is, if it is set to “0” (SP5: NO), the FM staging controller 25 proceeds to step SP12 since FM staging of data of an area in the HDD address will not be performed. Meanwhile, if the FM staging command flag of the selected HDD address is set to “1” (SP5: YES), the FM staging controller 25 reads the FM management table 34 from the memory 27 (SP6).

Subsequently, the FM staging controller 25 checks whether the FM area reservation flag of the selected HDD address of the logical volume management table 20 is set to “1” (SP7). If the FM area reservation flag of the HDD address is set to “1” (SP7: YES), the FM staging controller 25 proceeds to step SP12 since FM staging of data of an area in the HDD address has already been performed.

Meanwhile, if the FM area reservation flag of the HDD address is not set to “1”; that is, if it is set to “0” (SP7: NO), the FM staging controller 25 changes the HDD destaging prohibition flag of the HDD destaging prohibition flag column 20G in the selected HDD address of the logical volume management table 20 from “0” to “1” (SP8), and prohibits HDD destaging to the HDD address. The FM staging controller 25 is thereby able to effectively prevent HDD destaging to be performed during FM staging.

Subsequently, the FM staging controller 25 reads the data in an area of the selected HDD address (SP9). The FM staging controller 25 thereafter writes the read data into the FM block (SP10). In other words, the FM staging controller 25 performs FM staging of data in an area of the selected HDD address.

Subsequently, the FM staging controller 25 changes the HDD destaging prohibition flag of the HDD destaging prohibition flag column 20G in the selected HDD address of the logical volume management table 20 from “1” to “0” (SP11), and cancels the prohibition of HDD destaging to the HDD address.

The FM staging controller 25 eventually checks whether all HDD addresses of the logical volume management table 20 have been selected (SP12). If all HDD addresses have not been selected (SP12: NO), the FM staging controller 25 refers to the FM management table 34, and checks whether there is an unused FM page number in the reserved FM block (SP13).

If there is an unused FM page number in the reserved FM block (SP13: YES), the FM staging controller 25 returns to step SP4, and once again selects one HDD address among the HDD addresses of the logical volume management table 20 read from the control information storage area 12 (SP4), and thereafter repeats the same processing as the processing described above (SP4 to SP13). Meanwhile, if there is no unused FM page number in the reserved FM block (SP13: NO), the FM staging controller 25 returns to step SP1, once again refers to the FM management FIFO 31 to check whether there is an unused FM block (SP1), and thereafter repeats the same processing as the processing described above (SP1 to SP13).

Meanwhile, if all HDD addresses have been selected (SP12: YES), the FM staging controller 25 thereafter ends the control programs (not shown) in the FM staging controller 25 so as to end the FM staging processing routine RT1 shown in FIG. 7 and FIG. 8 (SP14).

The FM block release processing to be performed by the storage apparatus 3 of the storage system 1 according to the present embodiment is now explained.

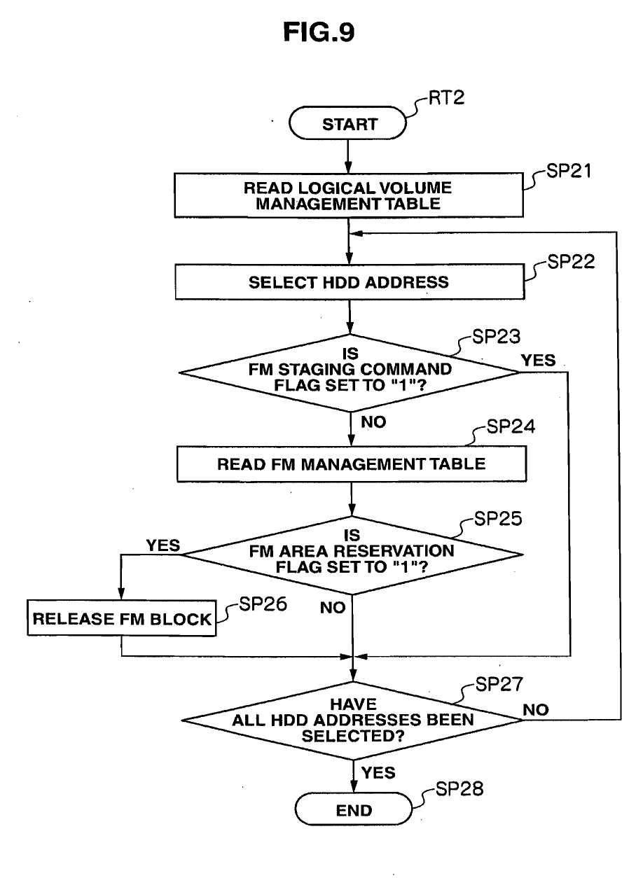

FIG. 9 is an example of a flowchart showing the specific processing routine of the FM staging controller 25 of the storage apparatus 3 concerning the FM block release processing to be performed by the storage apparatus 3 of the storage system 1.

If there is no unused FM block (SP1: NO), the FM staging controller 25 reads the logical volume management table 20 from the control information storage area 12 according to the FM block release processing routine RT2 shown in FIG. 9 (SP21). Subsequently, the FM staging controller 25 selects one HDD address among the HDD addresses of the logical volume management table 20 read from the control information storage area 12 (SP22).

Subsequently, the FM staging controller 25 checks whether the FM staging command flag of the selected HDD address is set to “1” (SP23). If the FM staging command flag of the selected HDD address is not set to “1”; that is, if it is set to “0” (SP23: YES), the FM staging controller 25 proceeds to step SP27 since FM staging of data in an area of the HDD address is scheduled to be performed. Meanwhile, if the FM staging command flag of the selected HDD address is set to “1” (SP23: YES), the FM staging controller 25 reads the FM management table 34 from the memory 27 (SP24).

Subsequently, the FM staging controller 25 checks whether the FM area reservation flag of the selected HDD address of the logical volume management table 20 is set to “1” (SP25). If the FM area reservation flag of the selected HDD address is not set to “1”; that is, if it is set to “0” (SP7: NO), the FM staging controller 25 proceeds to step SP27 since data in an area of the HDD address is not stored in the FM block. Meanwhile, if the FM area reservation flag of the HDD address is set to “1” (SP25: YES), the FM staging controller 25 releases the FM area reservation flag of all HDD addresses of the same FM block (changes the setting from “1” to “0”), moves the release pointer 31C of the FM management FIFO 31, and releases the FM block (SP26). The FM staging controller 25 also deletes the data of the released FM block.

The FM staging controller 25 eventually checks whether all HDD addresses of the logical volume management table 20 have been selected (SP27). If all HDD addresses have not been selected (SP27: NO), the FM staging controller 25 returns to step SP22, and once again selects one HDD address among the HDD addresses of the logical volume management table 20 read from the control information storage area 12 (SP22), and thereafter repeats the same processing as the processing described above (SP22 to SP27).

Meanwhile, if all HDD addresses have been selected (SP27: YES), the FM staging controller 25 thereafter ends the FM block release processing routine RT2 shown in FIG. 9 (SP28).

Although this embodiment explained a case of performing the FM staging processing and the FM block release processing as a result of executing the control programs (not shown) in the FM staging controller 25, the present invention is not limited thereto, and the foregoing processing may also be performed based on hardware control such as hardware sequence control without equipping a processor for executing the software programs in the FM staging controller 25.

The flow of writing data with the storage apparatus 3 of the storage system 1 according to the present embodiment is now explained. Although this embodiment explains a case where the RAID group is of a RAID 5 configuration, it goes without saying that other various configurations can also be employed.

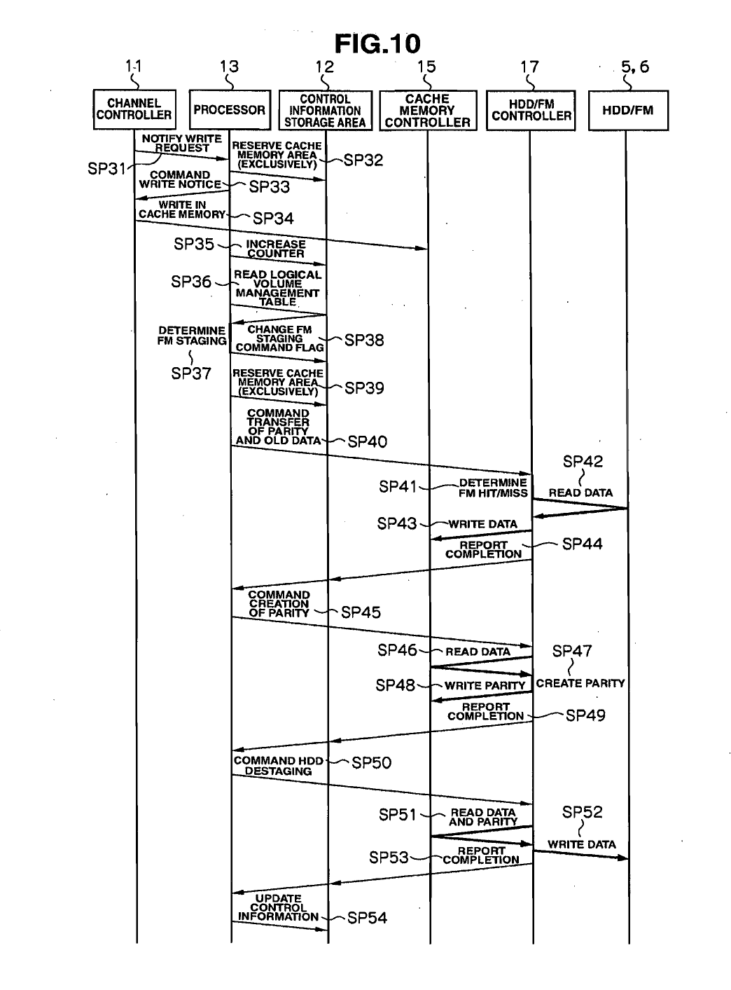

FIG. 10 is an example of a flowchart showing the specific processing routine of the channel controller 11, the processor 13, the control information storage area 12, the cache memory controller 15, and the HDD/FM controller 17 of the storage apparatus 3, as well as the hard disk drive 5 and the flash memory 6 concerning the flow of writing data with the storage apparatus 3 of the storage system 1.

Foremost, when the channel controller 11 receives a write request from the host system 2, it notifies the write request to the processor 13 (SP31).

Subsequently, the processor 13 exclusively reserves an area for storing data to be written into the hard disk drive 5 in the cache memory 14, and writes such reservation information into the control information storage area 12 storing the cache memory area management table (not shown) and the like managing the area of the cache memory 14 (SP32). The processor 13 thereafter notifies the write command to the channel controller 11 (SP33).

Subsequently, the channel controller 11 notifies the write command to the cache memory controller 15, and writes data in the reserved area of the cache memory 14 via the cache memory controller 15 (SP34).

Subsequently, the processor 13 increases the random write count or the sequential write count of the logical volume management table 20 according to the notified write request (SP35). The processor 13 thereafter reads the logical volume management table 20 from the control information storage area 12 (SP36). Next, the processor 13 refers to the logical volume management table 20 and performs FM staging determination for determining whether to perform FM staging of data to be written (SP37).

Subsequently, when FM staging of data to be written is to be performed, the processor 13 changes the FM staging command flag of the HDD address of the data to be written in the logical volume management table 20 from “0” to “1” (SP38). The processor 13 thereafter exclusively reserves an area for storing old data and parity data of the data to be written into the hard disk drive 5 in the cache memory 14, and writes such reservation information into the control information storage area 12 storing the cache memory area management table (not shown) and the like (SP39). Next, the processor 13 notifies a transfer command for transferring the old data and parity data to the cache memory 14 to the HDD/FM controller 17 (SP40).

Subsequently, the HDD/FM controller 17 refers to the FM management table 34 and performs FM hit/miss determination for determining whether the old data and parity data of the data to be written are stored in the flash memory 6 (SP41). The HDD/FM controller 17 thereafter reads the old data and parity data of the data to be written from the hard disk drive 5 or the flash memory 6 (SP42).

Subsequently, the HDD/FM controller 17 notifies the transfer command to the cache memory controller 15, and writes the old data and parity data into the reserved area of the cache memory 14 via the cache memory controller 15 (SP43). The HDD/FM controller 17 thereafter notifies the transfer command completion report to the processor 13 (SP44).

Subsequently, the processor 13 notifies the parity creation command of parity data of the data to be written to the HDD/FM controller 17 (SP45).

Subsequently, the HDD/FM controller 17 notifies the parity creation command to the cache memory controller 15, and reads the data to be written as well as the old data and parity data of such data to be written from the cache memory 14 via the cache memory controller 15 (SP46). The HDD/FM controller 17 thereafter creates parity data of the data to be written from the data to be written that was read from the cache memory 14 and the old data and parity data of such data to be written (SP47).

Subsequently, the HDD/FM controller 17 notifies the parity creation command (transfer command) to the cache memory controller 15, and writes the parity data of the data to be written into the reserved area of the cache memory 14 via the cache memory controller 15 (SP43). The HDD/FM controller 17 thereafter notifies the parity creation command completion report to the processor 13 (SP49).

Subsequently, the processor 13 notifies the HDD destaging command of the data to be written and the parity data of such data to the HDD/FM controller 17 (SP50).

Subsequently, the HDD/FM controller 17 notifies the HDD destaging command to the cache memory controller 15, and reads the data to be written and the parity data of such data from the cache memory 14 via the cache memory controller 15 (SP51). The HDD/FM controller 17 thereafter writes the data to be written and the parity data of such data into an area of the corresponding HDD address of the hard disk drive 5 (SP52). Next, the HDD/FM controller 17 notifies the HDD destaging command completion report to the processor 13 (SP53).

Subsequently, the processor 13 updates the control information of various tables such as the logical volume management table 20 stored in the control information storage area 12 (SP54).

The data write processing to be performed by the storage apparatus 3 of the storage system 1 according to the present embodiment is now explained.

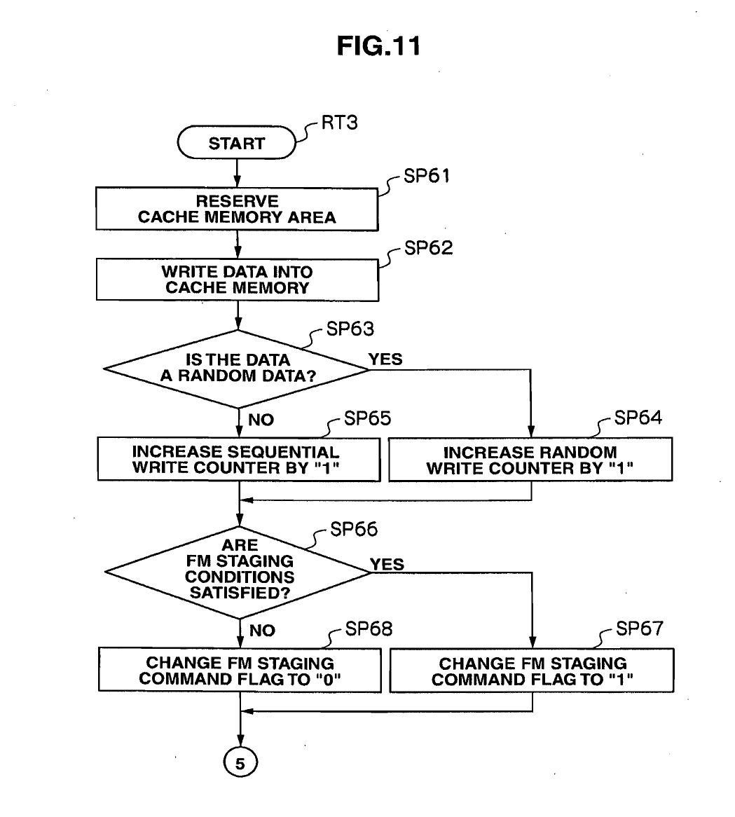

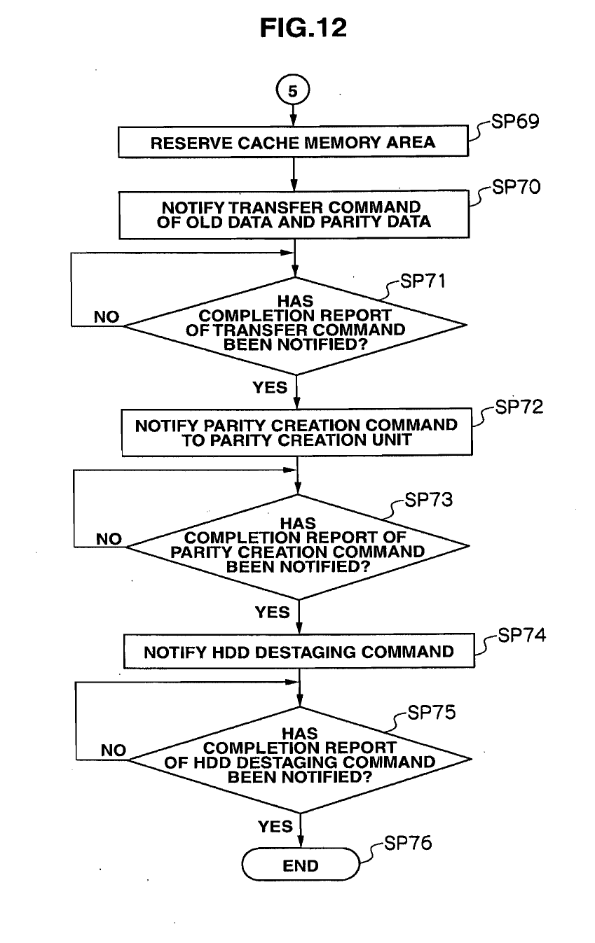

FIG. 11 and FIG. 12 are examples of flowcharts showing the specific processing routine of the processor 13 of the storage apparatus 3 concerning the data write processing to be performed by the storage apparatus 3 of the storage system 1.

When the processor 13 is notified of a write request from the channel controller 11, it exclusively reserves an area for storing data to be written into the hard disk drive 5 in the cache memory 14 and writes such reservation information into the control information storage area 12 storing the cache memory area management table (not shown) and the like by executing the control programs (not shown) in the processor 13 according to the data write processing routine RT3 shown in FIG. 11 and FIG. 12 (SP61). The processor 13 thereafter notifies the write command to the channel controller 11, and writes data into the reserved area of the cache memory 14 (SP62).

Subsequently, the processor 13 checks whether the data to be written into the hard disk drive 5 is random data (SP63). Specifically, the processor 13 determines that the data to be written is random data when the data to be written into the hard disk drive 5 is less than a prescribed data length or the subsequent write request is not a write request to the successive HDD addresses of the hard disk drive 5, and determines that the data to be written is sequential data when the data to be written into the hard disk drive 5 is greater than a prescribed data length or the subsequent write request is a write request to the successive HDD addresses of the hard disk drive 5.

If the data to be written into the hard disk drive 5 is random data (SP63: YES), the processor 13 increases the random write access count of the random write counter column 20C in the logical volume management table 20 by “1” (SP64). Meanwhile, if the data to be written into the hard disk drive 5 is not random data; that is, if it is sequential data (SP63: NO), the processor 13 increases the sequential write access count of the sequential write counter column 20D in the logical volume management table 20 by “1” (SP65).

The processor 13 eventually checks whether the HDD address of the data to be written in the logical volume management table 20 satisfies the FM staging conditions (SP66).

Specifically, the processor 13 determines that the FM staging conditions are satisfied when the random write access count of the random write counter column 20C is greater than the sequential write access count of the sequential write counter column 20D, or when the read access count of the read counter column 20E is greater than a prescribed count.

Meanwhile, the processor 13 determines that the FM staging conditions are not satisfied when the random write access count of the random write counter column 20C is less than the sequential write access count of the sequential write counter column 20D, or when the read access count of the read counter column 20E is less than a prescribed count.

Incidentally, the processor 13 may also determine that the FM staging conditions are satisfied when the random write access count is greater than a prescribed count, or when the random write access ratio is greater than a prescribed ratio, or when the read access ratio is greater than a prescribed ratio, and the like.

If the HDD address of the data to be written in the random write counter column 20C satisfies the FM staging conditions (SP66: YES), the processor 13 changes the FM staging command flag of the HDD address to “1” (SP67). Meanwhile, if the HDD address of the data to be written in the random write counter column 20C does not satisfy the FM staging conditions (SP66: NO), the processor 13 changes the FM staging command flag of the HDD address to “0” (SP68).

The processor 13 eventually exclusively reserves an area for storing the old data and parity data of the data to be written into the hard disk drive 5 in the cache memory 14, and writes such reservation information into the control information storage area 12 storing the cache memory area management table (not shown) and the like (SP69). The processor 13 thereafter notifies the transfer command of the old data and parity data to the external transfer DMA controller 23 of the HDD/FM controller 17 (SP70).

Subsequently, the processor 13 waits in standby mode to receive the completion report of the transfer command of the old data and parity data of the data to be written into the hard disk drive 5 from the internal transfer DMA controller 22 of the HDD/FM controller 17 (SP71). When the processor 13 eventually receives the transfer command completion report (SP71: YES), it notifies the parity creation command of parity data of the data to be written to the parity creation unit 21 of the HDD/FM controller 17 (SP72).

Subsequently, the processor 13 waits in standby mode to receive the completion report of the parity creation command of parity data of the data to be written from the parity creation unit 21 of the HDD/FM controller 17 (SP73). When the processor 13 eventually receives the parity creation command completion report (SP73: YES), it notifies the HDD destaging command of the data to be written and the parity data of such data to the internal transfer DMA controller 22 of the HDD/FM controller 17 (SP74).

Subsequently, the processor 13 waits in standby mode to receive the completion report of the HDD destaging command of the data to be written and the parity data of such data from the external transfer DMA controller 23 of the HDD/FM controller 17 (SP75). When the processor 13 eventually receives the HDD destaging command completion report (SP75: YES), it thereafter ends the control programs (not shown) in the processor 13 so as to end the data write processing routine RT3 shown in FIG. 11 and FIG. 12 (SP76).

The flow of reading data with the storage apparatus 3 of the storage system 1 according to the present embodiment is now explained.

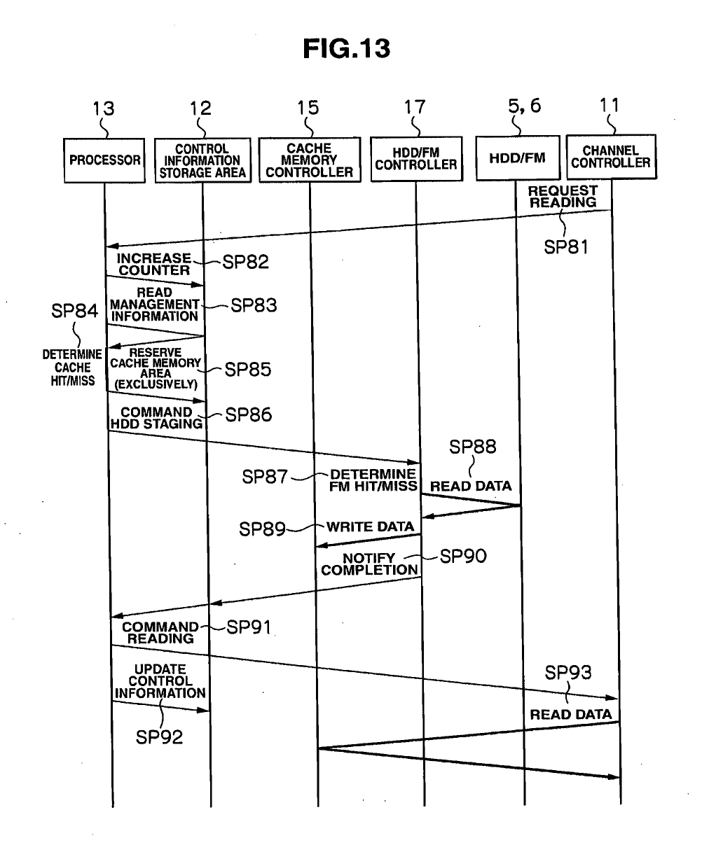

FIG. 13 is an example of a flowchart showing the specific processing routine of the processor 13, the control information storage area 12, the cache memory controller 15, the HDD/FM controller 17, the hard disk drive 5 and the flash memory 6 of the storage apparatus 3, as well as the channel controller 11 concerning the flow of reading data with the storage apparatus 3 of the storage system 1.

Foremost, when the channel controller 11 receives a read request from the host system 2, it notifies the read request to the processor 13 (SP81).

Subsequently, the processor 13 increases the read access count of the logical volume management table 20 (SP82). The processor 13 thereafter reads management information of the cache memory area management table (not shown) from the control information storage area 12 (SP83). Next, the processor 13 refers to the cache memory area management table and performs cache hit/miss determination for determining whether the data to be read is stored in the cache memory 14 (SP84).

Subsequently, the processor 13 exclusively reserves an area for storing data to be read into the host system 2 in the cache memory 14 when the data to be read is not stored in the cache memory 14, and writes such reservation information into the control information storage area 12 storing the cache memory area management table (not shown) and the like (SP85). The processor 13 thereafter notifies the data replication (hereinafter referred to as “HDD staging”) command of replicating data to be read from the hard disk drive 5 or the flash memory 6 to the cache memory 14 to the HDD/FM controller 17 (SP86).

Subsequently, the HDD/FM controller 17 refers to the FM management table 34 and performs FM hit/miss determination to the data to be read (SP87). The HDD/FM controller 17 thereafter reads the data to be read from the hard disk drive 5 or the flash memory 6 (SP88). Next, the HDD/FM controller 17 notifies the HDD staging command to the cache memory controller 15, and writes the data to be read into the reserved area in the cache memory 14 via the cache memory controller 15 (SP89). Then, the HDD/FM controller 17 notifies the HDD staging command completion report to the processor 13 (SP90).

Subsequently, the processor 13 notifies the read command of the data to be read to the channel controller 11 (SP91). The processor 13 thereafter updates the control information of various tables such as the logical volume management table 20 stored in the control information storage area 12 (SP92).

Subsequently, the channel controller 11 notifies the read command to the cache memory controller 15, and reads the data to be read from the cache memory and sends it to the host system 2 via the cache memory controller 15 (SP93).

The data read processing to be performed by the storage apparatus 3 of the storage system 1 according to the present embodiment is now explained.

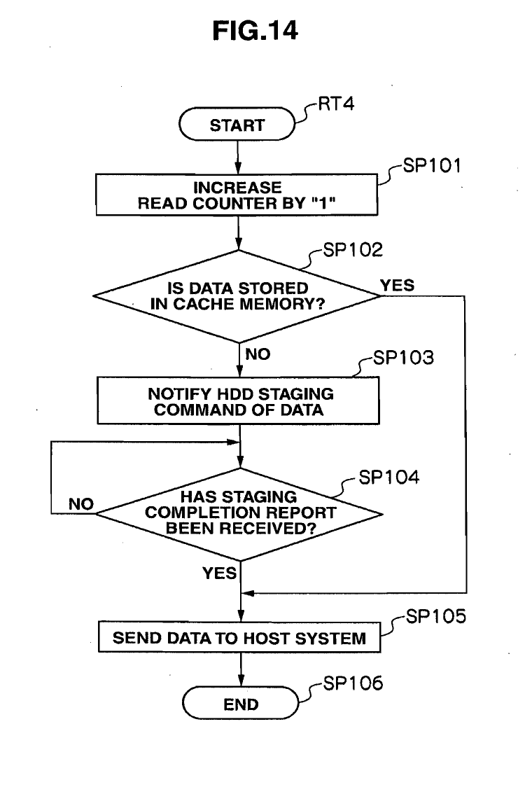

FIG. 14 is an example of a flowchart showing the specific processing routine of the processor 13 of the storage apparatus 3 concerning the data read processing to be performed by the storage apparatus 3 of the storage system 1.

When the processor 13 receives a read request from the channel controller 11, it increases the read access count of the read counter column 20E in the logical volume management table 20 by “1” by executing the control programs (not shown) in the processor 13 according to the data read processing routine RT4 shown in FIG. 14 (SPI01).

Subsequently, the processor 13 refers to the cache memory area management table and checks whether the data to be read is stored in the cache memory 14 (SP102). If the data to be read is stored in the cache memory 14 (SP102: YES), the processor 13 proceeds to step SP105. Meanwhile, if the data to be read is not stored in the cache memory 14 (SP102: NO), the processor 13 notifies the HDD staging command of the data to be read to the external transfer DMA controller 23 of the HDD/FM controller 17 (SP103).

Subsequently, the processor 13 waits in standby mode to receive the completion report of the HDD staging command of the data to be read from the internal transfer DMA controller 22 of the HDD/FM controller 17 (SP104). When the processor 13 eventually receives the HDD staging command completion report (SP104: YES), it notifies the read command of the data to be read to the channel controller 11, and reads the data to be read from the cache memory 14 and sends it to the host system 2 (SP105).

The processor 13 thereafter ends the control programs (not shown) in the processor 13 so as to end the data read processing routine RT4 shown in FIG. 14 (SP106).

The FM hit/miss determination processing to be performed by the storage apparatus 3 of the storage system 1 according to the present embodiment is now explained.

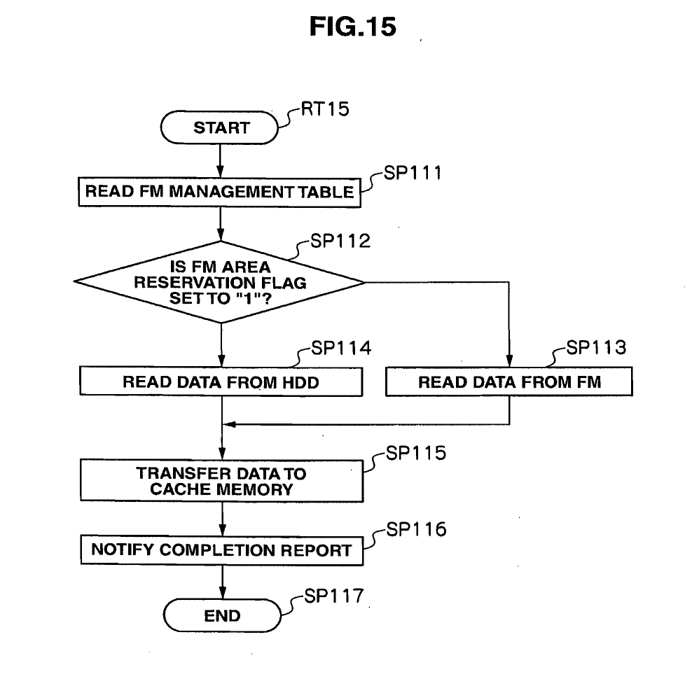

FIG. 15 is an example of a flowchart showing the specific processing routine of the HDD/FM controller 17 of the storage apparatus 3 concerning the FM hit/miss determination processing to be performed by the storage apparatus 3 of the storage system 1.

The external transfer DMA controller 23 of the HDD/FM controller 17 reads the FM management table 34 from the memory 27 by executing the control programs (not shown) in the external transfer DMA controller 23 according to the FM hit/miss determination processing routine RT5 shown in FIG. 15 when a transfer command is notified from the processor 13 or when an HDD staging command is notified from the processor 13 (SP111).

Subsequently, the external transfer DMA controller 23 checks whether the FM area reservation flag of the HDD address in an area storing the old data and parity data of the data to be written or the data to be read is set to “1” (SP112).

If the FM area reservation flag of the HDD address is “1” (SP112: YES), the external transfer DMA controller 23 reads the old data and parity data of the data to be written and the data to be read from the flash memory 6 since the old data and parity data of the data to be written and the data to be read are also stored in the flash memory 6, and stores such data in the memory 27 (SP113). The external transfer DMA controller 23 is thereby able to read the old data and parity data of the data to be written or the data to be read faster in comparison to a case of reading the same data from the hard disk drive 5.

Meanwhile, if the FM area reservation flag of the HDD address is not “1”; that is, if it is “0” (SP112: NO), the external transfer DMA controller 23 reads the old data and parity data of the data to be written and the data to be read from the hard disk drive 5 since the old data and parity data of the data to be written and the data to be read are not stored in the flash memory 6, and stores such data in the memory 27 (SP114).

The external transfer DMA controller 23 eventually notifies the transfer command or the HDD staging command to the internal transfer DMA controller 22 and the cache memory controller 15, transfers the old data and parity data of the data to be written and the data to be read to the cache memory 14 via the internal transfer DMA controller 22 and the cache memory controller 15 (SP115), and notifies the completion report of the transfer command or the HDD staging command to the processor 13 via the internal transfer DMA controller 22 (SP116).

The external transfer DMA controller 23 thereafter ends the control programs (not shown) in the external transfer DMA controller 23 so as to end the FM hit/miss determination processing routine RT5 shown in FIG. 15 (SP117).

The display of the maintenance management screen of the flash memory 6 in the management apparatus 18 is now explained.

When a maintenance management screen display request is sent from the management apparatus 18, the processor 13 reads the maintenance information management table 35 from the memory 27. Then, the processor 13 sends the maintenance management screen information to the management apparatus 18 based on the maintenance information management table 35, and displays the maintenance management screen 36 on the display unit of the management apparatus 18.

Although this embodiment explained a case of performing the FM hit/miss determination processing by executing the control programs (not shown) in the external transfer DMA controller 23, the present invention is not limited thereto, and the foregoing processing may also be performed based on hardware control such as hardware sequence control without equipping a processing for executing the software programs in the external transfer DMA controller 23.

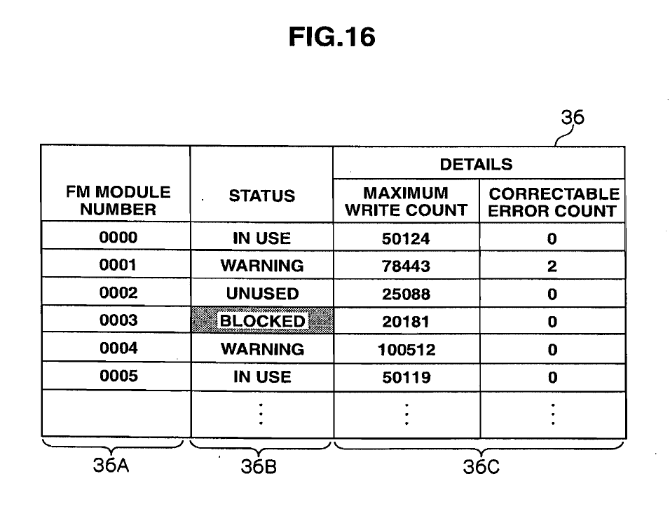

FIG. 16 shows the configuration of the maintenance management screen 36. The maintenance management screen 36 displays the status of the modularized flash memory 6, maximum write count and correctable error count. The maintenance management screen 36 is configured from an FM module number column 36A, a status column 36B, and a detail column 36C.

The FM module number column 35A displays the FM module number. The status column 36B displays information showing whether the modularized flash memory 6 is being used or blocked, and the current status of the modularized flash memory 6 based on the maximum write count and correctable error count of the maintenance information management table 35.

In the foregoing case, the status column 36B displays “In Use” when the modularized flash memory 6 is being used, and displays “Blocked” when the modularized flash memory 6 is being blocked. The status column 36B also displays “Warning” when the maximum write count or correctable error count of the modularized flash memory 6 is greater than a prescribed count, and it is dangerous to continue using the modularized flash memory 6 as is.

The detail column 36C is configured from a maximum write count column and a correctable error count column. The maximum write count column displays the maximum write count, which is the write count of the FM block with the greatest write count among the modularized flash memories 6. The correctable error count column displays the correctable error count of the modularized flash memory 6.

As a result of the processor 13 displaying the maintenance management screen 36 on the display unit of the management apparatus 18, the operator will be able to easily recognize the status of the modularized flash memory 6, the maximum write count and the correctable error count. The operator can block or replace the modularized flash memory 6 by recognizing the status of the modularized flash memory 6, the maximum write count and the correctable error count.

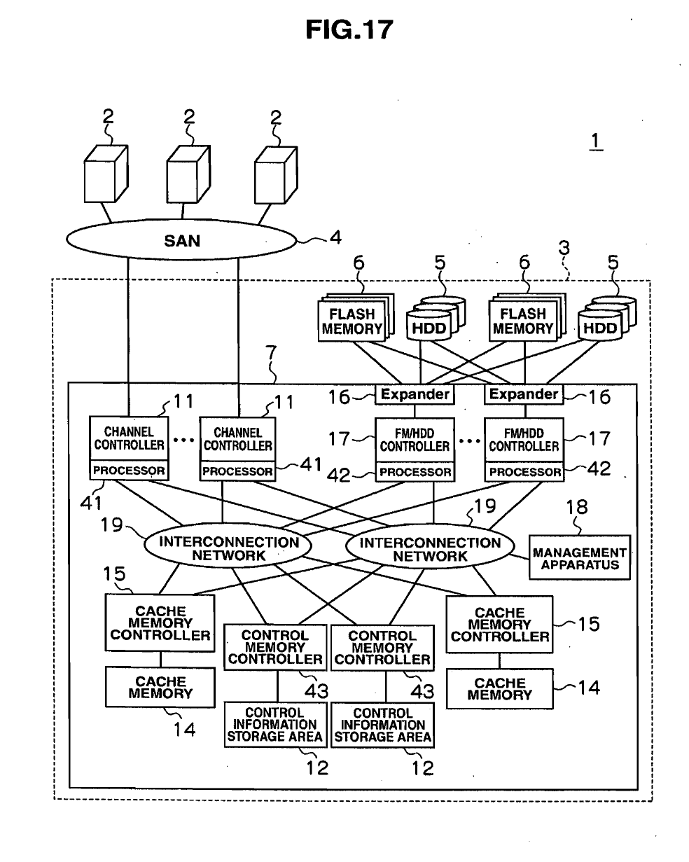

FIG. 17 shows the configuration of a storage system 1 according to another embodiment. Although this embodiment explained a case where the processor 13 is generally controlled by the channel controller 11, the cache controller 15 and the FM/HDD controller 17 in the storage system 1, the present invention is not limited thereto, and, as shown in FIG. 17, the processor 41 of the channel controller 11, the cache controller 15, the processor 42 of the FM/HDD controller 17 and the control memory controller 43 may independently perform the foregoing control, and the present invention can be applied to various other modes.

As described above, with the storage system 1, the HDD/FM controller 17 replicates data (performs FM staging) stored in the hard disk drive 5 to the flash memory 6 according to the usage such as the random write access, sequential write access and read access of the hard disk drive 5, and, when the processor 13 receives a read request from the host system 2 and corresponding data is stored in the flash memory 6, it reads data from the flash memory 6.

Accordingly, even when data stored in the hard disk drive 5 is replicated (subject to FM staging) to the flash memory 6, it is possible to effectively prevent the I/O processing performance with the host system 2 from temporarily deteriorating drastically, and considerably alleviate the load of the processor 13.

With the storage system 1, it is also possible to retain the identity of data when data stored in the hard disk drive 5 is replicated (subject to FM staging) to the flash memory 6. Moreover, with the storage system 1, the FM staging performance can be improved by preliminarily deleting the data of the released flash memory 6. Further, with the storage system 1, addresses can be managed easily by deleting data in FM block units.

With the storage system 1, when reading data from the flash memory 6, the load of the processor 13 can be alleviated even further by the HDD/FM controller 17 converting the HDD address into an FM block address and reading the data stored in the flash memory 6.

With the storage system 1, by displaying the operational state, maximum write count and correctable error count of the flash memory 6 on the display unit of the management apparatus 18, the operator will be able to easily identify a defective flash memory 6 or a flash memory 6 that may malfunction.

Although this embodiment explained a case of providing a flash memory 405 for storing data, the present invention is not limited thereto, and, for instance, the present invention can also be applied to various other nonvolatile memory devices such as a phase-change memory or a semiconductor memory.

Further, although this embodiment explained a case of employing a hard disk drive 5 as the disk-shaped storage device having a greater data write count than the flash memory 6, the present invention is not limited thereto, and, for instance, the present invention can also be applied to various other disk-shaped storage devices such as an optical disk or a magnetic optical disk.

Moreover, in this embodiment, the storage apparatus 3 can also be applied to storage apparatuses configured from a storage controller that stores data in one or more disk apparatuses or a storage medium, a solid state disk apparatus configured from a plurality of storage controllers, a tape library controller, an optical disk library controller, and a semiconductor disk controller, and a storage apparatus utilizing a nonvolatile memory as a flash memory.

In addition, although this embodiment explained a case of replicating data that satisfies the FM staging conditions from the hard disk drive 5 to the flash memory 6, the present invention is not limited thereto, and, for instance, the present invention may also be applied to cases of migrating data from the hard disk drive 5 to the flash memory 6, or to various other cases. In addition, HDD staging and HDD destaging may also similarly be applied to various modes in addition to the case of replicating data as described above.

The present invention can be broadly applied to storage apparatuses mounted with a hard disk drive and a flash memory.

What is claimed is:

1. A storage system comprising:
a plurality of disk drives;
a flash memory; and
a controller including a cache memory and configured to perform a copy process to copy data stored in a storage region provided with the plurality of disk drives to the flash memory according to a number of access requests to the storage region;
wherein if data requested by a read request is not stored in the cache memory, the controller is configured to transfer the requested data to the cache memory from the flash memory instead of transferring the requested data from the plurality of disk drives in case that the requested data is stored in the flash memory by the copy process.

2. The storage system according to claim 1, wherein the controller is configured to manage mapping information which is updated to indicate that data in a storage region provided with the plurality of disk drives is stored in the flash memory if the data in the storage region is copied to the flash memory.

3. The storage system according to claim 2, wherein the controller is configured to determine whether the requested data is stored in the flash memory by checking the mapping information.

4. The storage system according to claim 1, wherein the controller is configured to copy data stored in each of the plurality of storage regions provided with the plurality of disk drives to the flash memory asynchronously with the read request.

5. The storage system according to claim 1, wherein the controller is configured to increase the number of accesses to each of the plurality of storage regions provided with the plurality of disk drives even if data in each of the plurality of storage regions is stored in the cache memory.

6. The storage system according to claim 1, wherein:
if the requested data is stored in the cache memory, the controller is configured to transfer the requested data from the cache memory to a host computer, and
if the requested data is not stored in the cache memory, the controller is configured to transfer the requested data from the flash memory to the cache memory in case that the requested data is stored in the flash memory and transfer the requested data from the plurality of disk drives to the cache memory in case that the read data is not stored in the flash memory.

7. The storage system according to claim 1, wherein the controller is configured to operate the plurality of disk drives as a redundant array of independent disks (RAID) group and set a logical volume on the RAID group.

8. A storage system comprising:
a plurality of disk drives;
a flash memory; and
a controller including a cache memory and configured to:
transfer the requested data to the cache memory from the flash memory if data requested by a read request is not stored in the cache memory and in case that the requested data is stored in the flash memory; and
transfer the requested data to the cache memory from the plurality of disk drives in case that the requested data is not stored in the flash memory,
wherein the controller is configured to perform a copy process, asynchronously with processing the read request, to copy data stored in a storage region provided with the plurality of disk drives to the flash memory according to a number of access requests to the storage region.

9. The storage system according to claim 8, wherein the controller is configured to manage mapping information which is updated to indicate that data in a storage region provided with the plurality of disk drives is stored in the flash memory if the data in the storage region is copied to the flash memory.

10. The storage system according to claim 9, wherein the controller is configured to determine whether the requested data is stored in the flash memory by checking the mapping information.

11. The storage system according to claim 8, wherein the controller is configured to increase the number of accesses to each of the plurality of storage regions provided with the plurality of disk drives even if data in each of the plurality of storage regions is stored in the cache memory.

12. The storage system according to claim 8, wherein:
if the requested data is stored in the cache memory, the controller is configured to transfer the requested data from the cache memory to a host computer, and
if the requested data is not stored in the cache memory, the controller is configured to transfer the requested data from the flash memory to the cache memory in case that the requested data is stored in the flash memory and transfer the requested data from the plurality of disk drives to the cache memory in case that the read data is not stored in the flash memory.

13. The storage system according to claim 8, wherein the controller is configured to operate the plurality of disk drives as a redundant array of independent disks (RAID) group and set a logical volume on the RAID group.

14. A storage system comprising:
a plurality of disk drives;
a flash memory; and
a controller including a cache memory and configured to perform a copy process to copy data stored in a storage region provided with the plurality of disk drives to the flash memory according to a number of access requests to the storage region,
wherein if data requested by a read request is not stored in the cache memory, the controller is configured to transfer the requested data to the cache memory from the flash memory in case that the requested data is stored in the flash memory by the copy process, and transfer the requested data to the cache memory from the plurality of disk drives in case that the requested data is not stored in the flash memory by the copy process.

15. A method for a storage system including a plurality of disk drives, a flash memory, and a controller including a cache memory, the method comprising:
performing a copy process to copy data stored in a storage region provided with the plurality of disk drives to the flash memory according to a number of access requests to the storage region, and
if data requested by a read request is not stored in the cache memory, transferring the requested data to the cache memory from the flash memory instead of transferring the requested data from the plurality of disk drives in case that the requested data is stored in the flash memory by the copy process.

16. The method according to claim 15, further comprising:
managing mapping information which is updated to indicate that data in a storage region provided with the plurality of disk drives is stored in the flash memory if the data in the storage region is copied to the flash memory.

17. The method according to claim 16, further comprising:
determining whether the requested data is stored in the flash memory by checking the mapping information.

18. The method according to claim 15, further comprising:
coping data stored in each of the plurality of storage regions provided with the plurality of disk drives to the flash memory asynchronously with the read request.

19. The method according to claim 15, further comprising:
increasing the number of accesses to each of the plurality of storage regions provided with the plurality of disk drives even if data in each of the plurality of storage regions is stored in the cache memory.

20. The method according to claim 15, further comprising:
if the requested data is stored in the cache memory, transferring the requested data from the cache memory to a host computer, and
if the requested data is not stored in the cache memory, transferring the requested data from the flash memory to the cache memory in case that the requested data is stored in the flash memory and transferring the requested data from the plurality of disk drives to the cache memory in case that the read data is not stored in the flash memory.

21. The method according to claim 15, further comprising:
operating the plurality of disk drives as a redundant array of independent disks (RAID) group and setting a logical volume on the RAID group.

22. A method for a storage system including a plurality of disk drives, a flash memory, and a controller including a cache memory, the method comprising:
if data requested by a read request is not stored in the cache memory, transferring the requested data to the cache memory from the flash memory in case that the requested data is stored in the flash memory, and transferring the requested data to the cache memory from the plurality of disk drives in case that the requested data is not stored in the flash memory, and
performing a copy process asynchronously with processing the read request, to copy data stored in a storage region provided with the plurality of disk drives to the flash memory according to a number of access requests to the storage region.

23. The method according to claim 22, further comprising:
managing mapping information which is updated to indicate that data in a storage region provided with the plurality of disk drives is stored in the flash memory if the data in the storage region is copied to the flash memory.

24. The method according to claim 23, further comprising:
determining whether the requested data is stored in the flash memory by checking the mapping information.

25. The method according to claim 22, further comprising:
increasing the number of accesses to each of the plurality of storage regions provided with the plurality of disk drives even if data in each of the plurality of storage regions is stored in the cache memory.

26. The method according to claim 22, further comprising:
if the requested data is stored in the cache memory, transferring the requested data from the cache memory to a host computer, and
if the requested data is not stored in the cache memory, transferring the requested data from the flash memory to the cache memory in case that the requested data is stored in the flash memory and transferring the requested data from the plurality of disk drives to the cache memory in case that the read data is not stored in the flash memory.

27. The method according to claim 22, further comprising:
operating the plurality of disk drives as a redundant array of independent disks (RAID) group and setting a logical volume on the RAID group.
